(19) United States
(12) Patent Application Publication
(10) Pub. No.: US 2007/0101782 A1
(43) Pub. Date: May 10, 2007

(54) Key-changeable lock

(76) Inventor: Yang Shen, Suzhou (CN)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/582,198

(22) PCT Filed: Dec. 17, 2004
(86) PCT No.: PCT/CN04/01461

§ 371 Date: Jun. 9, 2006

(30) Foreign Application Priority Data
Dec. 22, 2003 (CN) 200320123249.9

(51) Int. Cl. E05B 29/04

(52) U.S. Cl. 70/495

(57) ABSTRACT

The invention relates to a key-changeable lock including a lock housing and a lock cylinder provided within the lock housing. The lock cylinder includes a shell for the lock cylinder, a locking hole into which a key can be inserted and a locking block mounted on the shell. A sliding block and a toothed piece are provided in the shell. The locking block is abutted against the sliding block. Several toothed slides are slidably provided within the sliding block. The locking block can be located at two working positions. At a first working position, the locking block is not held in the block groove and the teeth of the toothed piece engage with those of the toothed slide. At a second working position, the locking block is held in the block groove and the teeth of the toothed piece disengage from those of the toothed slide.

### FIELD OF THE INVENTION

The invention relates to a key-changeable lock.

### BACKGROUND ART

A conventional lock includes a lock housing and a lock cylinder provided within the lock housing. The lock cylinder includes a shell for the lock cylinder, a locking hole provided in the shell into which a key can be inserted, and a locking block slidably mounted on the shell. Typically, one key can just unlock one lock. Therefore, people have to hold a group of various keys corresponding to different locks, and it is inconvenient to find out the key corresponding with a particular lock from the group of keys. If the group of keys were lost or were duplicated by other people for purpose of hostility, all the locks corresponding with the group of keys must be replaced and thus it is very inconvenient to do so. Therefore, for the conventional locks, they are impossible to be used with a new key after the original key is lost.

### SUMMARY OF THE INVENTION

It is an object of the invention to provide a key-changeable lock, wherein the key of the lock can be substituted.

In order to achieve above object, the invention provides a key-changeable lock as defined bellow. The key-changeable lock includes a lock housing and a lock cylinder provided within the lock housing. The lock cylinder includes a shell, a locking hole provided on the shell and into which a key can be inserted, and a locking block slidably mounted on the shell. A sliding block is slidably provided in the shell. Several toothed slides are slidably provided within the sliding block. A toothed piece is slidably disposed within the shell. The toothed piece is provided with a block groove. The locking block can be located at two working positions. At a first working position, the locking block is not held in the block groove and the teeth of the toothed piece engage with those of the toothed slide. At a second working position, the locking block is held in the block groove and the teeth of the toothed piece disengage from those of the toothed slide.

According to above technical solution, the advantage of the invention compared with the prior art is the key-changeable lock. Because the engagement between the teeth in the lock cylinder can be changed by the key, it is possible to change the key of the lock so that a new key can be substituted for the old key and the old key can be invalided. Therefore, after the key is lost or duplicated by others, it is just necessary to substitute a new key without substituting the lock cylinder.

### BRIEF DESCRIPTION OF THE DRAWINGS

FIG. 1 is a front cross-sectional view of an embodiment of a lock according to the invention;

FIG. 2 is a cross-sectional view of FIG. 1 taken along A-A direction, where the locking block is at a first working position; and

FIG. 3 is a cross-sectional view of FIG. 1 taken along A-A direction, where the locking block is at a second working position.

### LIST OF REFERENCE NUMBERS

1. locking block; 2. lock cylinder; 3. toothed piece; 4. toothed slide; 5. compression spring; 6. sliding block; 7. spring; 8. key; 9. lock housing; 10. pin; 11. locking hole; 12. shell for the lock cylinder; 13. bore for compression spring; 14. spring bore; 15. block groove; 16. contactor; locking groove; and 18. guiding slant.

### DETAILED DESCRIPTION OF THE PREFERRED EMBODIMENT

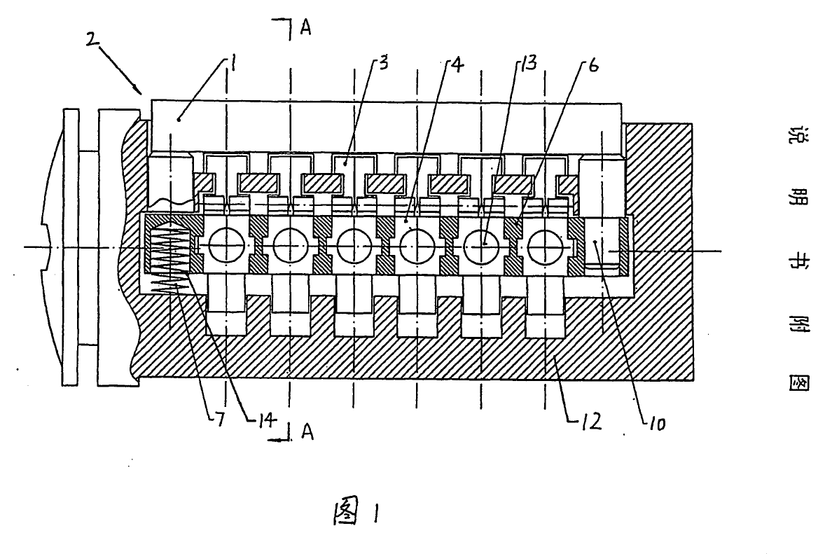

FIGS. 1 to 3 illustrate a key-changeable lock which includes a lock housing 9 and a lock cylinder 2 provided within the lock housing 9. The lock cylinder 2 includes a shell 12 for the lock cylinder, a locking hole 11 provided on the shell 12 and into which a key 8 can be inserted, and a locking block 1 slidably mounted on the shell 12. A sliding block 6 is slidably provided in the shell 12. The locking block 1 is abutted against the sliding block 6. Several springs 7 are provided between the sliding block 6 and the shell 12. Several toothed slides 4 are slidably provided within the sliding block 6. A compression spring 5 is disposed between each toothed slide 4 and the sliding block 6. A contactor 16, which is located within the locking hole 11, is fixed to the toothed slide 4. A toothed piece 3 is slidably disposed within the shell 12. The toothed piece 3 is provided with a block groove 15. The sliding direction of the sliding block 6 is perpendicular to that of the toothed slide 4. The locking block 1 can be situated at and operatively moved between two different working positions. At a first working position, the locking block 1 is not held in the block groove 15 and the teeth of the toothed piece 3 engage with those of the toothed slide 4. At a second working position, the locking block 1 is held in the block groove 15 and the teeth of the toothed piece 3 disengage from those of the toothed slide 4. A locking groove 17 is provided in the lock housing 9. When the locking block 1 is located at the first working position, the locking block 1 is received in the locking groove. The locking groove 17 is provided with guiding slants 18.

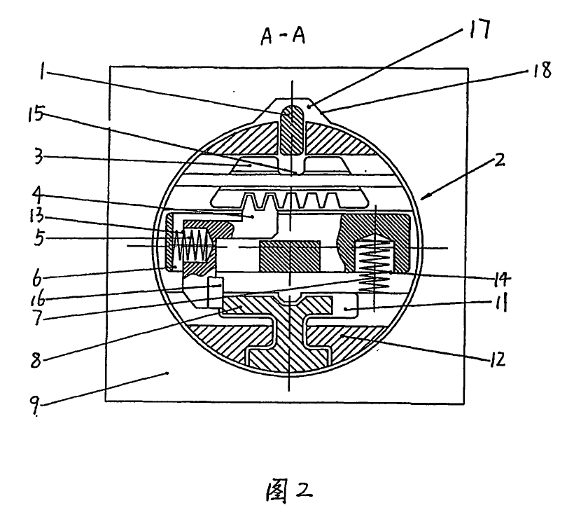

As shown in FIG. 2, when the key 8 is inserted in the locking hole 11 without being rotated, the teeth on the key 8 push the contactors 16 of the toothed slides 4 so as to slide the toothed slide 4 towards the left. Thus the toothed piece 3 slides towards the left due to the engagement of the teeth of the toothed slide 4 with those of the toothed piece 3. This can enable the locking groove 17 on the toothed piece 3 to be aligned with the locking block 1, while the locking block 1 is still at its first working position.

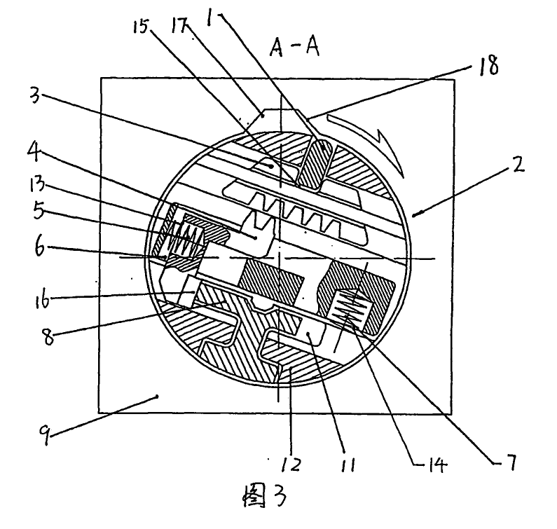

As shown in FIG. 3, when the key 8 is rotated, the lock cylinder 2 is rotated synchronously with the rotation of the key 8. Then, the locking block 1 comes out from the locking groove 17 along the guiding slant 18. Under the pressing of the lock housing 9, the locking block 1 slides into the block groove 15. Therefore, the locking block 1 reaches at its second working position. In this case, the lock cylinder 2 can be freely rotated with the key 8 in the lock housing 9, and thus the lock can be unlocked. Also as shown in FIG. 1, since the locking block 1 pushes against pins 10 fixed within the sliding block 6, the downward sliding of the locking block 1 will result in the downward sliding of the sliding block 6, and thus the spring 7 is compressed. As shown in FIG. 3, this can result that the toothed slide 4 provided within the sliding block 6 sliding down so that the teeth of the toothed slide 4 disengage from those of the toothed piece 3. In this case, if the key does not need to be changed, then after the lock is unlocked, by rotating the lock cylinder 2 with the key 8 so as to align the locking block 1 to the locking groove 17 on the lock housing 9, the sliding block 6 is pushed up by the compressed spring 7. As the locking block 1 is pushed by the pins 10, the locking block 1 is brought into the locking groove 17 on the lock housing 9. Thus, the teeth of the toothed slide 4 engage with those of the toothed piece 3 again. Because the teeth form of the key 8 does not change with respect to the teeth form of the contactor 16 of the toothed slide 4, the engagement position of the teeth of the toothed slide 4 with those of the toothed piece 3 is not changed. After the key 8 has been taken out, the lock is lock again. In the case shown in FIG. 3, in order to change the key with a new one, the key can be removed from the locking hole 11 and a new key substituted can be inserted into the locking hole 11. The new key is rotated reversely so as to align the locking block 1 to the locking groove 17 on the lock housing 9 and then is removed from the locking hole 11. Because the teeth form of the new key has been changed with respect to the teeth form of the contactor 16 of the toothed slide 4, a new engagement position of the teeth of the toothed slide 4 with those of the toothed piece 3 is established. For the new engagement position, the new key is valid and the old key is invalid. It means that the old key is changed by a new one. Next time, it is necessary to use the new key to unlock the lock again. Otherwise, the locking block 1 cannot be aligned to the block groove 15 of the toothed piece 3, and the lock cannot be unlocked.

1. A key-changeable lock, comprising:
a lock housing (9); and
a lock cylinder (2) provided within the lock housing (9), the lock cylinder (2) including a shell (12) for the lock cylinder, a locking hole (11) provided on the shell (12) and into which a key (8) can be inserted, and a locking block (1) slidably mounted on the shell (12);
wherein a sliding block (6) is slidably provided in the shell (12), the locking block (1) is abutted against the sliding block (6), toothed slides (4) are slidably provided within the sliding block (6), and a toothed piece (3) provided with a block groove (15) is slidably disposed within the shell (12), and
wherein the locking block (1) can be located at two working positions, and at a first working position, the locking block (1) is not held in the block groove (15) and the teeth of the toothed piece (3) engage with the teeth of the toothed slide (4), and at a second working position, the locking block (1) is held in the block groove (15) and the teeth of the toothed piece (3) disengage from those of the toothed slide (4).

2. The key-changeable lock of claim 1, wherein springs (7) are provided between the sliding block (6) and the shell (12).

3. The key-changeable lock of claim 1, wherein a compression spring (5) is provided between the toothed slide (4) and the sliding block (6).

4. The key-changeable lock of claim 1, wherein the sliding direction of the sliding block (6) is perpendicular to that of the toothed piece (3).

5. The key-changeable lock of claim 1, wherein a contactor (16) is fixed on the toothed slide (4) and located within the locking hole (11).

6. The key-changeable lock of claim 1, wherein a locking groove (17) is provided on the lock housing (9); when the locking block (1) is located at the first working position, the locking block (1) is received in the locking groove; and each side face of the locking groove (17) is provided with a guiding slant (18).
